(19) United States
(12) Patent Application Publication
(10) Pub. No.: US 2021/0405990 A1
(43) Pub. Date: Dec. 30, 2021

(54) METHOD, DEVICE, AND STORAGE MEDIUM FOR DEPLOYING MACHINE LEARNING MODEL

(71) Applicant: EMC IP Holding Company LLC, Hopkinton, MA (US)

(72) Inventors: Jin Li, Shanghai (CN); Jinpeng Liu, Shanghai (CN); Zhen Jia, Shanghai (CN); Qiang Chen, Shanghai (CN)

(21) Appl. No.: 16/936,813

(22) Filed: Jul. 23, 2020

(30) Foreign Application Priority Data
Jun. 29, 2020 (CN) 202010611060.2

(51) Int. Cl. G06F 8/61; G06F 8/30; G06N 20/00; H04L 29/08

(52) U.S. Cl. CPC G06F 8/64; H04L 67/34; G06N 20/00; G06F 8/30

(57) ABSTRACT

Embodiments of the present disclosure relate to a method, a device, and a storage medium for deploying a machine learning model. The method includes: determining, at a first computing device, a configuration of a second computing device, wherein computing power of the first computing device is greater than that of the second computing device and the configuration of the second computing device indicates at least a processor architecture of the second computing device; acquiring a program code of a trained machine learning model corresponding to the configuration of the second computing device, wherein the program code is adapted to the processor architecture; and providing the program code of the machine learning model to the second computing device, for deploying the machine learning model on the second computing device.

### RELATED APPLICATION(S)

The present application claims priority to Chinese Patent Application No. 202010611060.2, filed Jun. 29, 2020, and entitled “Method, Device, and Storage Medium for Deploying Machine Learning Model,” which is incorporated by reference herein in its entirety.

### FIELD

Embodiments of the present disclosure generally relate to the field of computers, and more particularly, to a method, a device, and a storage medium for deploying a machine learning model.

### BACKGROUND

In recent years, with the development of computer technologies, the Internet of Things has been increasingly applied to all aspects of people's life. A core of the Internet of Things technology is analysis of data obtained by an Internet of Things (IoT) device (for example, various temperature sensors, position sensors, image sensors, meters, and the like). The sensor data may advantageously help people to make early warnings, predictions, or the like. However, such sensor data is massive in most cases, so a resource overhead required for transmission and processing of the sensor data is also large. At present, with the development of artificial intelligence technologies, it is proposed to use a machine learning model for achieving a more accurate data analysis. However, how to efficiently deploy and execute a machine learning model for an IoT application has become a current focus of attention.

### SUMMARY

A solution for deploying a machine learning model is provided in the embodiments of the present disclosure.

In a first aspect of the present disclosure, a method for deploying a machine learning model is provided. The method includes: determining, at a first computing device, a configuration of a second computing device, wherein computing power of the first computing device is greater than that of the second computing device and the configuration of the second computing device indicates at least a processor architecture of the second computing device; acquiring a program code of a trained machine learning model corresponding to the configuration of the second computing device, wherein the program code is adapted to the processor architecture; and providing the program code of the machine learning model to the second computing device, for deploying the machine learning model on the second computing device.

In a second aspect of the present disclosure, a computing device is provided. The computing device includes: at least one processor; and at least one memory storing computer program instructions, the at least one memory and the computer program instructions being configured to cause, with the at least one processor, the computing device to perform actions including: determining a configuration of another computing device, wherein computing power of the computing device is greater than that of the another computing device and the configuration of the another computing device indicates at least a processor architecture of the another computing device; acquiring a program code of a trained machine learning model corresponding to the configuration of the another computing device, wherein the program code is adapted to the processor architecture; and providing the program code of the machine learning model to the another computing device, for deploying the machine learning model on the another computing device.

In a third aspect of the present disclosure, a computer-readable storage medium storing machine-executable instructions is provided, wherein when executed by at least one processor, the machine-executable instructions cause the at least one processor to implement the method described according to the first aspect.

In a fourth aspect of the present disclosure, a computer program product is provided. The computer program product is tangibly stored on a non-volatile computer-readable medium and includes machine-executable instructions, and the machine-executable instructions, when executed, cause a device to implement the method according to the first aspect above.

This Summary is provided to introduce the selection of concepts in a simplified form, which will be further described in the Detailed Description below. The Summary is neither intended to identify key features or main features of the present disclosure, nor intended to limit the scope of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same component.

FIG. 1 is a schematic diagram of an environment in which an embodiment of the present disclosure can be implemented;

FIG. 2 is a schematic diagram of an implementation environment according to some embodiments of the present disclosure;

FIG. 3 is a schematic diagram of an implementation environment according to some embodiments of the present disclosure;

FIG. 4 is a schematic diagram of an automatic deployment method according to some embodiments of the present disclosure;

FIG. 5 is a flowchart of a method for deploying a machine learning model according to some embodiments of the present disclosure; and

FIG. 6 is a block diagram of an example device that can be configured to implement an embodiment of the present disclosure.

### DETAILED DESCRIPTION

The principles of the present disclosure will be described below with reference to some example embodiments shown in the accompanying drawings. Although illustrative embodiments of the present disclosure are shown in the accompanying drawings, it should be understood that these embodiments are described merely to enable those skilled in the art to better understand and then implement the present disclosure, and do not limit the scope of the present disclosure in any way.

The term “including” and variants thereof used herein indicate open-ended inclusion, that is, “including, but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

Machine learning may be mainly divided into three stages, namely, a training stage, a testing stage, and an application stage (also referred to as a reasoning stage). In the training stage, a given machine learning model may be trained by using a large number of training samples, and the training keeps on iterating until the machine learning model can obtain consistent reasoning from the training samples that is similar to the reasoning that can be made by human intelligence. Through training, the machine learning model may be considered as being capable of learning mapping or association relationships between inputs and outputs from training data. After training, a parameter set value of the machine learning model is determined. In the testing stage, the trained machine learning model may be tested by using a test sample to determine the performance of the machine learning model. In the application stage, the machine learning model may be configured to process actual input data based on the parameter set value obtained by training, so as to provide a corresponding output.

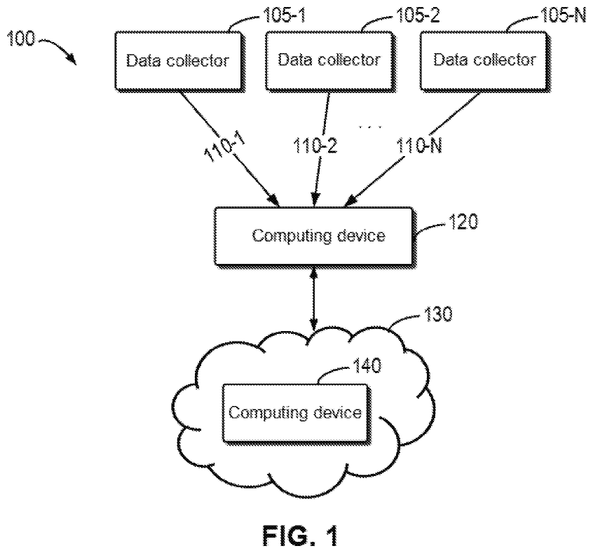

FIG. 1 is a schematic diagram of environment 100 in which an embodiment of the present disclosure can be implemented. As shown in FIG. 1, environment 100 includes one or more data collectors 105-1, 105-2, . . . , 105-N (individually or collectively referred to as data collector 105, where N is a positive integer greater than or equal to 1), computing device 120, cloud computing architecture (also referred to as “cloud”) 130, and computing device 140 provided in cloud computing architecture 130. Environment 100 may be considered as an Internet of Things (IoT). It should be understood that the number and arrangement of the devices shown in FIG. 1 are only schematic, and should not be construed as limitations to the solution of this application.

In some embodiments, computing device 120 may be an edge computing node, for example, a computing node with a gateway function (also referred to as an edge gateway). Computing device 120 may be connected to and communicate with one or more data collectors 105 in a wired or wireless manner, and may be configured to receive to-be-analyzed data 110-1, 110-2, . . . , 110-N (individually or collectively referred to as to-be-analyzed data 110) from one or more data collectors 105. An analysis operation on to-be-analyzed data 110 may be implemented by a device with computing power in environment 100.

Data collector 105 may be any device capable of collecting data, which may be, for example, various similar sensors. Examples of data collector 105 include an image sensor, a motion sensor, a temperature sensor, a position sensor, an illumination sensor, a humidity sensor, a power sensing sensor, a gas sensor, a smoke sensor, a humidity sensor, a pressure sensor, a positioning sensor, an accelerometer, a gyroscope, a meter, a decibel sensor, and so on. In the data analysis work, it may be necessary to perform abnormal data detection on to-be-analyzed data 110 in order to timely discover an abnormal event in an environment where data collector 105 is deployed and provide an early warning of the abnormal event to facilitate subsequent processing actions.

Cloud computing architecture 130 is remotely deployed to provide computing, software, data access, and storage services. The processing in cloud computing architecture 130 may be referred to as “cloud computing.” In various implementations, the cloud computing uses an appropriate protocol to provide services through a wide area network (such as the Internet). For example, a provider of cloud computing architecture 130 provides applications through the wide area network, and the applications are accessible through a web browser or any other computing components. Software or components of cloud computing architecture 130 and corresponding data may be stored on a server at a remote location. Computing resources in cloud computing architecture 130 may be merged at a remote data center location or they may be dispersed. Cloud computing infrastructures may provide services through a shared data center, even if they are each represented as a single point of access for users. Therefore, the components and functions described herein may be provided from a service provider at a remote location by using cloud computing architecture 130. Alternatively, they may be provided from a conventional server, or they may be installed on a client terminal device directly or in another manner. It should be understood that, although shown as single device 140, computing device 140 may be any component or set of components with computing power in cloud computing architecture 130. Therefore, various parts of computing device 140 may be distributed in cloud computing architecture 130.

A current trend is to implement data analysis and abnormality detection by using a machine learning model. The abnormality detection of data may be considered as a classification problem to be solved by the machine learning model. Training and application of the machine learning model need the support of processing, storage, and other computing resources. In order to achieve required processing precision or depending on a model type used, the machine learning model may be of a large size, and therefore, the requirements for computing resources may be higher.

In practical applications, requirements and criteria for data analysis and data collected from a data source (that is, a data collector) may change over time. For example, initially it may only be expected to roughly determine whether the data is abnormal data or not, and then it may be expected to more accurately determine more subdivided types of the abnormal data and/or more subdivided types of the normal data. The number of the data collectors may also be increased or decreased, resulting in changes in a type of to-be-processed data, the amount of to-be-processed data, and the like. Therefore, during the training and application of the machine learning model, another challenge is how to evolve the model. However, compared with applications of the machine learning model, the training of the model may consume more resources and take a longer time.

In consideration of the above aspects, if updates and applications of the machine learning model are all deployed in a cloud computing architecture with higher computing power, computing resources need not be a concern, but real-time feedback of the data analysis may be affected because there may be a great delay in the process of transmitting to-be-analyzed data from a data collector to the cloud computing architecture and then returning analysis results from the cloud computing architecture. Therefore, it is difficult to meet the requirements of real-time detection of data abnormality. For example, in a scenario where an operating state of a vehicle is detected by using a speed sensor, it is a very important application to quickly detect an abnormal speed to predict a possible traffic accident.

In another possible implementation, if the updates and the applications of the machine learning model are all deployed in a computing device closer to a data source, such as an edge computing node in the IoT, the delay in the abnormality detection may be reduced, but at the expense of computing resources of the edge computing node. As a result, both the updates of the model and the application process of the model are less efficient.

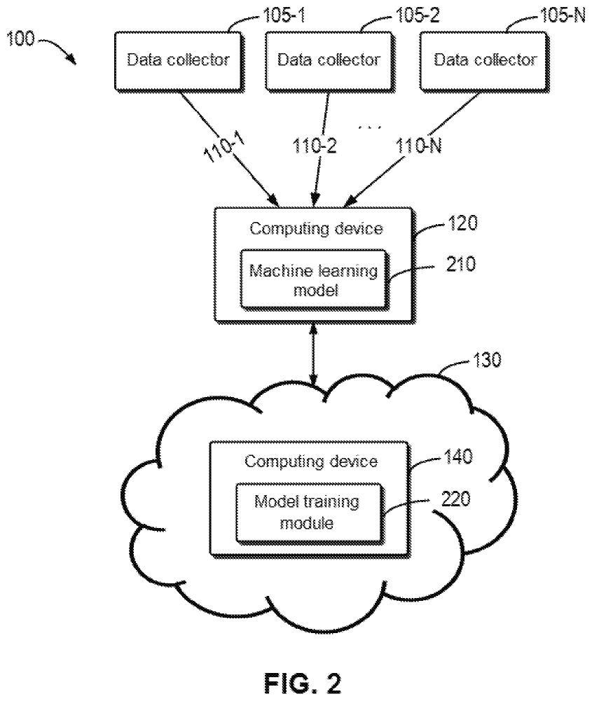

FIG. 2 is a schematic diagram of an example environment of applications and updates of a distributed model according to some embodiments of the present disclosure. As shown in FIG. 2, trained machine learning model 210 is deployed at computing device 120. Computing device 140 with higher computing power includes model training module 220 that is configured to update machine learning model 210.

Computing device 140 may save machine learning model 210 currently deployed at computing device 120, and then update machine learning model 210 according to a model update criterion. Computing device 140 redeploys updated machine learning model 210 to computing device 120. Thus, computing device 120 may continue processing to-be-analyzed data set 110 from data collector 105 by using new machine learning model 210.

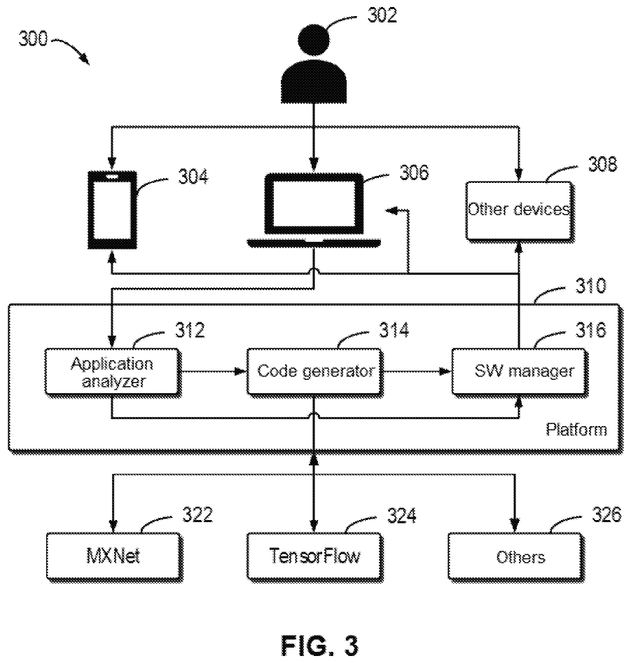

FIG. 3 is a schematic diagram of implementation environment 300 according to some embodiments of the present disclosure. In implementation environment 300, user 302 may operate mobile phone 304, notebook computer 306, and/or other edge computing devices (referred to as “other devices”) 308. The edge computing devices may also be referred to as edge computing nodes. In the example shown in FIG. 3, user 302 operates notebook computer 306 and provides a device list of edge computing devices to platform 310, wherein platform 310 may be implemented in the cloud. Alternatively, each edge computing device may also provide its own information to platform 310, so that platform 310 may extract the device list of edge computing devices according to the device information provided by each edge computing device. For example, the edge computing device may be identified by an identifier such as a network protocol (IP) address or a media access control (MAC) address.

User 302 may further provide application analyzer 312 with information of a machine learning model to be deployed by each edge computing device, for example, specify a deep learning (DL) framework. FIG. 3 shows deep learning framework MXNet 322, TensorFlow 324, and other deep learning frameworks 326. User 302 may specify a deep learning framework used by each edge computing device, so that code generator 314 can generate code according to the specified deep learning framework. In some examples, only one deep learning framework may be provided. In this case, the user does not need to specify any deep learning framework.

Application analyzer 312 may store a device list of edge computing devices and analyze edge computing devices, e.g., all the edge computing devices in the device list. Application analyzer 312 may acquire and record device information, for example, configurations of the edge computing devices, especially processor architectures. Different processor architectures generally use different instruction sets, and thus different code needs to be used for adaptation. For example, a central processing unit (CPU), a graphics processing unit (GPU), a field programmable gate array (FPGA), and the like all use different instruction sets, and thus different program code needs to be deployed. In an example, the device information may further include a device type, a manufacturer, version information, and so on.

Code generator 314 may acquire a configuration of an edge computing device and a specified deep learning framework from application analyzer 312, and automatically generate a machine learning model, for example, an executable file of a machine learning model, based on the configuration of the edge computing device and the specified deep learning framework. The machine learning models may be trained machine learning models, and thus they are also referred to as reasoning programs.

Software (“SW”) manager 316 may acquire the device list of edge computing devices from application analyzer 312 to deploy the machine learning model generated by code generator 314 to the edge computing device. Since the edge computing devices may be added or reduced at any time, software manager 316 may acquire information of a newly added edge computing device, search historical machine learning models for a machine learning model corresponding to the configuration of the edge computing device, and deploy the machine learning model into the edge computing device.

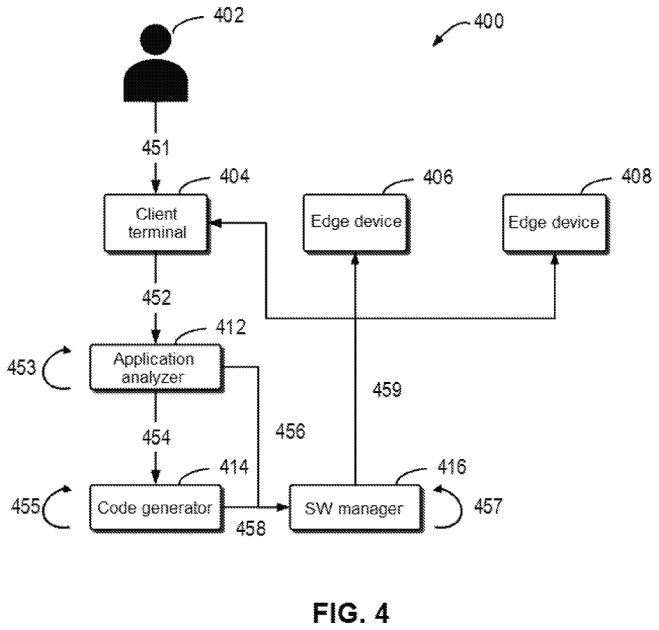

FIG. 4 is a schematic diagram of deployment method 400 according to some embodiments of the present disclosure. In 451, user 402 may configure a machine learning model (for example, a reasoning program), for example, specify a deep learning framework, through client terminal 404. In addition, the user may set, through client terminal 404, a device list of edge computing devices where the reasoning program is to be deployed.

In 452, client terminal 404 sends configurations of all the edge computing devices in the device list to the platform, particularly to application analyzer 412. In 453, application analyzer 412 may store the received device list and analyze the configurations of all the edge computing devices in the device list, that is, a configuration list. Application analyzer 412 may acquire an inference program according to the configuration list, and provide the inference program to an edge computing device corresponding to a corresponding configuration. For example, application analyzer 412 may further classify configurations in the configuration list, in which the same machine learning model or inference program may be used for configurations of the same class. For example, all edge computing devices with an X86 architecture may be put in the same class.

In 454, application analyzer 412 sends an analysis result to code generator 414. In 455, code generator 414 generates a program or code of the machine learning model, for example, an executable file, based on the configuration of the edge computing device and a target deep learning framework.

In 456, software manager 416 acquires the device list and the analysis result from application analyzer 412. In 457, software manager 416 may establish a connection, for example, a remote procedure call (RPC) connection, with client terminal 404, edge devices 406, 408, and other edge computing devices according to the acquired device list. Through the RPC, the platform may remotely deploy runtime libraries and code on the edge computing devices and start executing the code.

In some examples, software manager 416 may acquire information such as a configuration and a type of each edge computing device through the connection with the edge computing device. Alternatively, software manager 416 may also acquire information such as a configuration and a type of an edge computing device from application analyzer 412. In 458, software manager 416 selects a machine learning model corresponding to each edge computing device, for example, an executable file of the machine learning model, from the code generated by code generator 414. In 459, software manager 416 deploys the corresponding machine learning model (for example, the executable file) to each edge computing device and starts running the executable files.

In some examples, when an edge computing device is added, the edge computing device may send its configuration to application analyzer 412 and/or software manager 416. Software manager 416 may search, according to the configuration of the edge computing device, previously generated code for code matching the configuration of the edge computing device. If such code is found, the code may be directly deployed to the edge computing device, thereby reducing the amount of computation.

For example, software manager 416 not only is responsible for automatic deployment and automatic execution, but also may store program files (for example, the executable files) of the machine learning models generated by code generator 414 and information about the files (for example, DL frameworks, DL models, target device configurations or types, and so on). For example, N recent program files may be stored, and the number of N may be predefined. After application analyzer 412 obtains the configuration information from client terminal 404, application analyzer 412 may check whether a new machine learning model uses the same configuration as the stored N program files. If the new machine learning model has the same configuration as one of the N program files, application analyzer 412 may not trigger code generator 414 to perform code generation, but may trigger software manager 416 to start automatic deployment and execution.

In some examples, in order to deploy reasoning programs of machine learning models for large-scale edge computing devices, software manager 416 may start automatic deployment of each device in parallel to improve the efficiency of the automatic deployment process.

According to an embodiment of the present disclosure, by analyzing all devices in the device list, the code generator may generate a variety of executable files for all types of requirements of a target device. The software manager may find, by using the information stored in the application analyzer, a corresponding executable file of the target device and automatically deploy the executable file on the target device. Through automatic deployment of DL reasoning programs, a DL reasoning program may be easily deployed on an edge computing device without any manual assistance, especially for an implementation with a wide coverage. The automatic execution function makes it easier to maintain DL reasoning on the edge computing device.

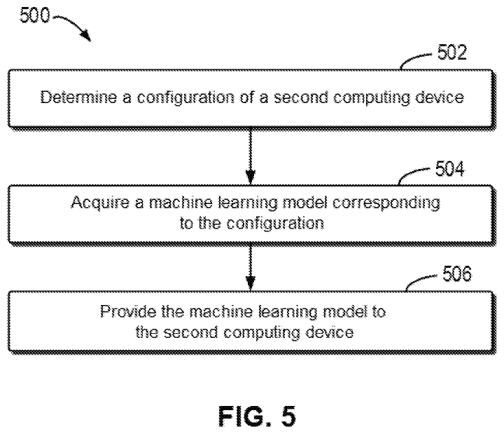

FIG. 5 is a flowchart of method 500 for deploying a machine learning model according to an embodiment of the present disclosure. Method 500 may be implemented by computing device 140 or cloud computing architecture 130 in FIG. 1, and may be implemented in the example environments of FIG. 2 and FIG. 3.

In 502, computing device 140 (sometimes also referred to as a first computing device) determines a configuration of computing device 120 (sometimes also referred to as a second computing device). For example, the configuration of the second computing device may be a type of the second computing device, for example, including a processor architecture and the like. Computing power of the first computing device is greater than that of the second computing device, and in one example, the first computing device is a cloud and the second computing device is an edge computing device.

In 504, computing device 140 acquires a trained machine learning model, for example, an inference program, especially an executable file, corresponding to the configuration of computing device 120.

In 506, computing device 140 provides the acquired machine learning model to computing device 120 to deploy the machine learning model on computing device 120. For example, the executable file of the machine learning model may start execution on computing device 120.

In some examples, computing device 120 may include a plurality of second computing devices, for example, as shown in FIG. 3 to FIG. 4. Method 500 may include determining a configuration list of the plurality of second computing devices; acquiring a machine learning model corresponding to a corresponding configuration in the configuration list; and providing the machine learning model to one of the plurality of second computing devices that corresponds to the corresponding configuration. An inference program is generated based on different configurations, and only one inference program can be generated for edge computing devices having the same configuration, thereby reducing the amount of computation during generation of the inference program.

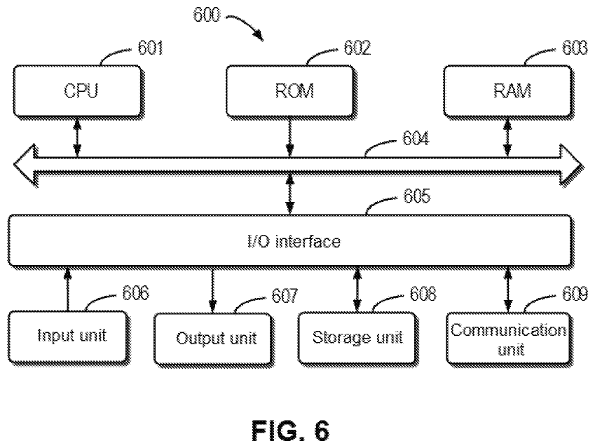

FIG. 6 is a schematic block diagram of device 600 that may be configured to implement an embodiment of the present disclosure. As shown in FIG. 6, device 600 includes central processing unit (CPU) 601 that may perform various appropriate actions and processing according to computer program instructions stored in read-only memory (ROM) 602 or computer program instructions loaded from storage unit 608 to random access memory (RAM) 603. Various programs and data required for the operation of device 600 may also be stored in RAM 603. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disk; and communication unit 609, such as a network card, a modem, and a wireless communication transceiver. Communication unit 609 allows device 600 to exchange information/data with other devices over a computer network such as the Internet and/or various telecommunication networks.

The various processes and processing described above, for example, method 500, may be performed by CPU 601. For example, in some embodiments, method 500 can be implemented as a computer software program that is tangibly included in a machine-readable medium such as storage unit 608. In some embodiments, part or all of the computer program may be loaded and/or installed onto device 600 via ROM 602 and/or communication unit 609. When the computer program is loaded to RAM 603 and executed by CPU 601, one or more steps of method 500 described above may be performed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device capable of retaining and storing instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, RAM, ROM, an erasable programmable read-only memory (EPROM or flash memory), a static random access memory (SRAM), a portable compact disk read-only memory (CD-ROM), a digital versatile disk (DVD), a memory stick, a floppy disk, a mechanical coding device such as a punch card or protrusions in a groove on which instructions are stored, and any appropriate combination of the above. The computer-readable storage medium used here is not construed as transient signals themselves, such as radio waves or other freely propagating electromagnetic waves, electromagnetic waves propagating through waveguides or other transmission media (for example, optical pulses through fiber-optic cables), or electrical signals transmitted through electrical wires.

The computer-readable program instructions described herein can be downloaded from a computer-readable storage medium to various computing/processing devices, or downloaded to an external computer or external storage device via a network such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages. The programming languages include object-oriented programming languages such as Smalltalk and C++ and conventional procedural programming languages such as “C” language or similar programming languages. The computer-readable program instructions can be executed entirely on a user computer, executed partly on a user computer, executed as a separate software package, executed partly on a user computer and partly on a remote computer, or executed entirely on a remote computer or a server. In a case where a remote computer is involved, the remote computer can be connected to a user computer through any kind of networks, including a local area network (LAN) or a wide area network (WAN), or can be connected to an external computer (e.g., connected through the Internet using an Internet service provider). In some embodiments, an electronic circuit, such as a programmable logic circuit, a field programmable gate array (FPGA), or a programmable logic array (PLA), can be customized by utilizing status information of the computer-readable program instructions. The electronic circuit may execute the computer-readable program instructions to implement various aspects of the present disclosure.

Various aspects of the present disclosure are described here with reference to flowcharts and/or block diagrams of the method, the apparatus (the system), and the computer program product according to the embodiments of the present disclosure. It should be understood that each block in the flowcharts and/or block diagrams as well as a combination of blocks in the flowcharts and/or block diagrams may be implemented by using the computer-readable program instructions.

The computer-readable program instructions may be provided to a processing unit of a general purpose computer, a special purpose computer, or other programmable data processing apparatuses to produce a machine, such that the instructions, when executed by the processing unit of the computer or other programmable data processing apparatuses, generate an apparatus for implementing the functions/actions specified in one or more blocks in the flowcharts and/or block diagrams. The computer-readable program instructions may also be stored in a computer-readable storage medium, to cause a computer, a programmable data processing apparatus, and/or other devices to work in a specific manner, such that the computer-readable medium storing the instructions includes an article of manufacture that contains instructions for implementing various aspects of the functions/actions specified in one or more blocks in the flowcharts and/or block diagrams.

The computer-readable program instructions may also be loaded onto a computer, other programmable data processing apparatuses, or other devices, so that a series of operating steps are performed on the computer, other programmable data processing apparatuses, or other devices to produce a computer-implementing process, so that the instructions executed on the computer, other programmable data processing apparatuses, or other devices implement the functions/actions specified in one or more blocks in the flowcharts and/or block diagrams.

The flowcharts and block diagrams in the accompanying drawings show the architectures, functionalities, and operations of possible implementations of the system, the method, and the computer program product according to a plurality of embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, the functions marked in the blocks may also occur in an order different from that marked in the accompanying drawings. For example, two successive blocks may actually be performed basically in parallel, or they may be performed in an opposite order sometimes, depending on the functions involved. It should be further noted that each block in the block diagrams and/or flowcharts as well as a combination of the blocks in the block diagrams and/or flowcharts may be implemented by using a dedicated hardware-based system for executing specified functions or actions or by a combination of dedicated hardware and computer instructions.

The embodiments of the present disclosure have been described above. The above description is illustrative, rather than exhaustive, and is not limited to the disclosed embodiments. Numerous modifications and alterations are apparent to those of ordinary skill in the art without departing from the scope and spirit of the illustrated various embodiments. The selection of terms used herein is intended to best explain the principles and practical applications of the embodiments or the technological improvements to technologies on the market, and to otherwise enable persons of ordinary skill in the art to understand the embodiments disclosed herein.

What is claimed is:

1. A method for deploying a machine learning model, comprising:
determining, at a first computing device, a configuration of a second computing device, wherein computing power of the first computing device is greater than that of the second computing device and the configuration of the second computing device indicates at least a processor architecture of the second computing device;
acquiring a program code of a trained machine learning model corresponding to the configuration of the second computing device, wherein the program code is adapted to the processor architecture; and
providing the program code of the machine learning model to the second computing device, for deploying the machine learning model on the second computing device.

2. The method of claim 1, wherein the second computing device comprises a plurality of second computing devices, and the method further comprises:
determining a configuration list of the plurality of second computing devices;
acquiring a machine learning model corresponding to a corresponding configuration in the configuration list; and
providing the machine learning model to one of the plurality of second computing devices that corresponds to the corresponding configuration.

3. The method of claim 1, wherein acquiring a program code of the machine learning model comprises:
determining a deep learning framework for the second computing device; and
generating, based on the deep learning framework and the configuration of the second computing device, the program code of the machine learning model.

4. The method of claim 1, wherein the first computing device is a cloud, and the second computing device is an edge computing device.

5. The method of claim 1, wherein acquiring a program code of the machine learning model comprises acquiring an executable file of the machine learning model, and providing the program code of the machine learning model to the second computing device comprises sending the executable file to the second computing device so that the second computing device starts executing the executable file.

6. A computing device, comprising:
at least one processor; and
at least one memory storing computer program instructions, the at least one memory and the computer program instructions being configured to cause, with the at least one processor, the computing device to perform actions comprising:
determining a configuration of another computing device, wherein computing power of the computing device is greater than that of the another computing device and the configuration of the another computing device indicates at least a processor architecture of the another computing device;
acquiring a program code of a trained machine learning model corresponding to the configuration of the another computing device, wherein the program code is adapted to the processor architecture; and
providing the program code of the machine learning model to the another computing device, for deploying the machine learning model on the another computing device.

7. The computing device of claim 6, wherein the another computing device comprises a plurality of another computing devices, and the actions further comprise:
determining a configuration list of the plurality of another computing devices;
acquiring a machine learning model corresponding to a corresponding configuration in the configuration list; and
providing the machine learning model to one of the plurality of another computing devices that corresponds to the corresponding configuration.

8. The computing device of claim 6, wherein acquiring a program code of the machine learning model comprises:
determining a deep learning framework for the another computing device; and
generating, based on the deep learning framework and the configuration of the another computing device, the program code of the machine learning model.

9. The computing device of claim 6, wherein the computing device is a cloud, and the another computing device is an edge computing device.

10. The computing device of claim 6, wherein acquiring a program code of the machine learning model comprises acquiring an executable file of the machine learning model, and providing the program code of the machine learning model to the another computing device comprises sending the executable file to the another computing device so that the another computing device starts executing the executable file.

11. A non-transitory computer-readable storage medium storing machine-executable instructions, wherein when executed by at least one processor, the machine-executable instructions cause the at least one processor to implement a method for deploying a machine learning model, the method comprising:
determining, at a first computing device, a configuration of a second computing device, wherein computing power of the first computing device is greater than that of the second computing device and the configuration of the second computing device indicates at least a processor architecture of the second computing device;
acquiring a program code of a trained machine learning model corresponding to the configuration of the second computing device, wherein the program code is adapted to the processor architecture; and
providing the program code of the machine learning model to the second computing device, for deploying the machine learning model on the second computing device.

12. The non-transitory computer-readable storage medium of claim 11, wherein the second computing device comprises a plurality of second computing devices, and the method further comprises:
determining a configuration list of the plurality of second computing devices;
acquiring a machine learning model corresponding to a corresponding configuration in the configuration list; and
providing the machine learning model to one of the plurality of second computing devices that corresponds to the corresponding configuration.

13. The non-transitory computer-readable storage medium of claim 11, wherein acquiring a program code of the machine learning model comprises:
determining a deep learning framework for the second computing device; and
generating, based on the deep learning framework and the configuration of the second computing device, the program code of the machine learning model.

14. The non-transitory computer-readable storage medium of claim 11, wherein the first computing device is a cloud, and the second computing device is an edge computing device.

15. The non-transitory computer-readable storage medium of claim 11, wherein acquiring a program code of the machine learning model comprises acquiring an executable file of the machine learning model, and providing the program code of the machine learning model to the second computing device comprises sending the executable file to the second computing device so that the second computing device starts executing the executable file.

16. A computer program product comprising the non-transitory computer-readable storage medium of claim 11.
